(19) United States
(12) Patent Application Publication
(10) Pub. No.: US 2005/0039408 A1
(43) Pub. Date: Feb. 24, 2005

(54) Method of making a tool component

(76) Inventor: Klaus Tank, Bedfordview (DE)

Correspondence Address: Timothy J Keefer;Seyfarth Shaw, 55 E Monroe street, Chichago, IL, 60603, US

(21) Appl. No.: 10/501,044

(22) PCT Filed: Jan. 9, 2003
(86) PCT No.: PCT/IB03/00030

(30) Foreign Application Priority Data
Jan. 10, 2002 (ZA) 02/0220

(51) Int. Cl. C09C 1/68; B24D 3/02; C09K 3/14

(52) U.S. Cl. 51/307; 51/309

(57) ABSTRACT

In a method of producing a tool component a plurality of fibres is formed into a bundle. Each fibre has a core comprising a mass of ultra-hard abrasive particles or precursor to said ultra-hard abrasive particles and optionally a second phase, and a coating comprising a mixture of carbide particles and particulate binder metal. After extruding the bundle of fibres, the bundle is severed transverse to its length to produce a layer. The layer is placed on a surface of a substrate and the layer and substrate are subjected to elevated temperature and pressure conditions at which the ultra-hard abrasive particles are crystallographically stable. The composition of the core and coating may be interchanged in the method.

### BACKGROUND OF THE INVENTION

This invention relates to a method of making a tool component.

Tool components utilising diamond compacts, also known as PCD, and cubic boron nitride compacts, also known as PCBN, are extensively used in drilling, milling, cutting and other such abrasive applications. The tool component will generally comprise a layer of PCD or PCBN bonded to a support, generally a cemented carbide support. The PCD or PCBN layer may present a sharp cutting edge or point or a cutting or abrasive surface.

U.S. Pat. No. 6,063,502 describes a material useful for producing the abrasive layer of a tool component. The material comprises a first structural phase comprising a hard material selected from the group consisting of cemented carbide materials, PCD, PCBN and mixtures thereof, and a second structural phase comprising a material that is different to that used to form the first structural phase, the second structural phase being in contact with at least a portion of the first structural phase. The material includes repeated structural units, disposed across a working surface of the material, each unit comprising an ordered micro-structure of the first and second structural phases. In use, this material is applied to a surface of a substrate and then bonded to that substrate.

This United States patent describes various methods of producing the material. One such method comprises producing a plurality of fibres having a core of the first structural phase and a coating of the second structural phase, orienting the fibres parallel to a common axis and then extruding them into a rod. The extruded rod can be cut into a desired geometry for the tool component or sliced to form a cutting surface for placement on to a substrate.

### SUMMARY OF THE INVENTION

According to the present invention, a method of producing a tool component includes the steps of:
(1) providing a plurality of fibres, each fibre having a core comprising a mass of ultra-hard abrasive particles or precursor to said ultra-hard abrasive particles and optionally a second phase, and a coating comprising a mixture of carbide particles and particulate binder metal,
(2) producing a bundle of the fibres,
(3) severing the bundle transverse to its length to produce a layer,
(4) placing the layer on a surface of a substrate, and
(5) subjecting the layer and substrate to elevated temperature and pressure conditions at which the ultra-hard abrasive particles are crystallographically stable.

The composition of the core and coating may be interchanged in the method described above. Such a method forms another aspect of the invention.

### BRIEF DESCRIPTION OF THE DRAWINGS

FIGS. 1 to 6 illustrate schematically steps in an embodiment of the invention.

### DESCRIPTION OF EMBODIMENTS

In accordance with the method of producing a tool component of the invention a plurality of fibres is provided, each fibre having a core which is coated. For convenience, the invention will be described with reference to the core consisting of a mass of ultra-hard particles or precursor to said ultra-hard abrasive particles and the coating consisting of carbide particles and particulate binder metal. It is to be understood that the components of the core and coating may be interchanged.

A bundle is formed of the fibres, which is then severed transverse to its length to produce a layer. The layer is then applied to a surface of a substrate, whereafter the layer and substrate are subjected to conditions of elevated temperature and pressure at which the ultra-hard abrasive particles are crystallographically stable.

The product which is produced is a tool component comprising the substrate having a working portion produced from the layer bonded to a surface thereof. The working portion comprises a composite material comprising essentially a honeycomb structure of cemented carbide and abrasive compact material within the pores of the honeycomb structure and bonded to the honeycomb structure. The pores of the honeycomb structure may be ordered or random.

The ultra-hard abrasive particles will generally be diamond or cubic boron nitride. Thus, the abrasive compact which is produced in the pores of the honeycomb structure will preferably be PCD or PCBN. That PCD or PCBN will preferably contain a second phase which will typically be a solvent/catalyst for the ultra-hard abrasive particles.

The particulate components of the core and coating of the fibres will preferably be in bonded form using a bonding agent such as an organic binder. An example of a particularly suitable binder is methyl cellulose. Generally, this binder will be removed, e.g. by heating, prior to subjecting the substrate and layer to the elevated temperature and pressure conditions.

The carbide particles of the coating will typically be tungsten carbide particles, tantalum carbide particles or molybdenum carbide particles. The metal binder may be any metal binder known in the art such as iron, nickel, cobalt or an alloy containing one or more of these metals.

The coating may comprise one or more layers. In the case that the coating comprises more than one layer, each layer will differ from the adjacent layer or layers in physical and/or chemical properties. For example, a particular layer of the coating may contain coarser or finer carbide particles than the adjacent layer or layers. Alternatively, or additionally, a particular layer may contain a different metal binder to that in the layer or layers to which it is adjacent.

The layer which is applied to a surface of the substrate is in a green state form. As such, it has a flexibility and may be applied to surfaces which are flat or profiled, e.g. a curved surface. The layer may be moulded into a shape complimentary to the substrate to which it is to be bonded.

The substrate will typically be a cemented carbide substrate.

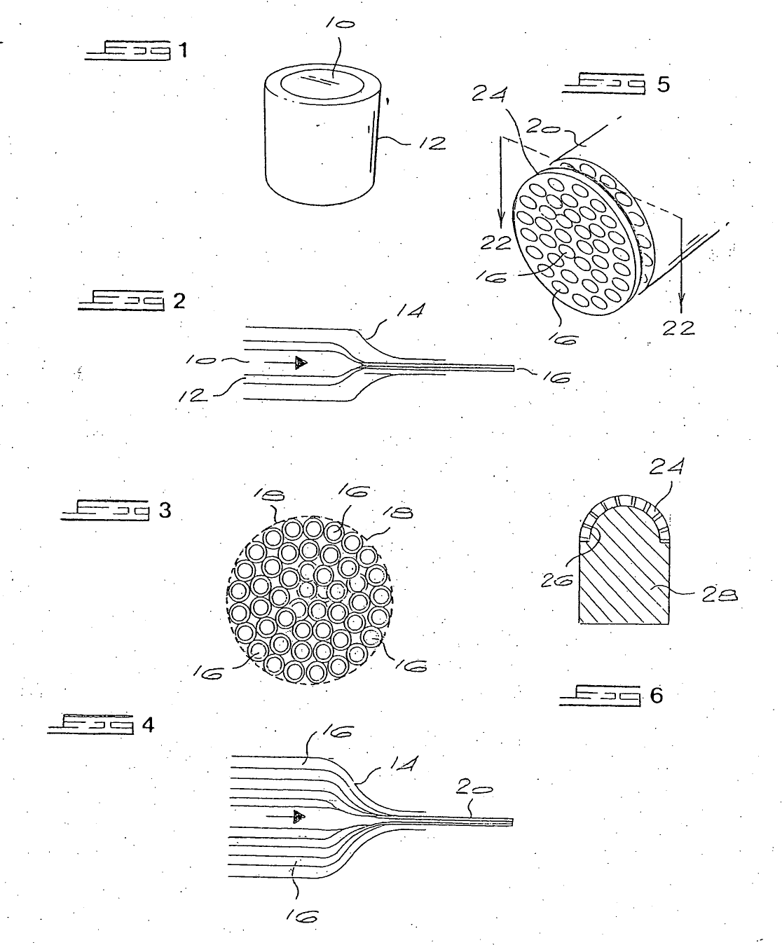

An embodiment of the invention will now be described with reference to the accompanying drawings. Referring first to FIG. 1, there is shown a fibre comprising a core 10 and a coating 12. The core 10 comprises a mixture of diamond particles and a diamond solven/catalyst, in particulate form, bonded into coherent form by means of an organic binder. The coating 12 comprises a mixture of carbide particles and metal binder, in particulate form, again bonded into coherent form by means of an organic binder.

The fibre of FIG. 1 is reduced in cross-section by extruding it through nozzle 14 (see FIG. 2). A plurality of the fibres 16 extruded through nozzle 14 form a bundle 18. The bundle 18 is then further extruded through nozzle 14 as shown in FIG. 4. The extruded product is a rod 20 comprising the fibres 16 pressed into each other, as shown in FIG. 5. This rod 20 may then be severed in a direction transverse to its length, as shown by the dotted lines 22. The severed piece or layer 24 may be removed. Thus, the layer 24, which has flexibility, may be placed on the curved surface 26 of a substrate 28, as shown in section by FIG. 6.

The green state product of FIG. 6 is placed in a suitable capsule for insertion into the reaction zone of a conventional high temperature/high pressure apparatus. The organic binder is first removed by heating the capsule to drive off the binder. The capsule is then placed in the reaction zone and the contents of the capsule subjected to diamond synthesis conditions. Typically, the pressure applied will be of the order of 4 to 8 GPa and the temperature will be of the order of 1300° C. to 1700° C. This has the effect of producing PCD out of the material of core 10 and cemented carbide out of the material of coating 12. The PCD will be bonded to the cemented carbide. The layer 24 will be bonded to the surface 26 of the substrate 28 producing a working portion for the tool component. The working portion will have a honeycomb structure, similar to that shown by FIG. 6, of cemented carbide and PCD within the pores of the honeycomb structure.

Although not present in this embodiment, if desired, an interlayer may be provided between the layer 24 and the surface 26 of the substrate 28. Such an interlayer would be selected to provide intermediate properties for stress management at the interface between the layer 24 and the substrate surface 26.

1. A method of producing a tool component including the steps of: (1) providing a plurality of fibres, each fibre having a core comprising a mass of ultra-hard abrasive particles or precursor to said ultra-hard abrasive particles and optionally a second phase, and a coating comprising a mixture of carbide particles and particulate binder metal, (2) producing a bundle of the fibres, (3) severing the bundle transverse to its length to produce a layer, (4) placing the layer on a surface of a substrate, and (5) subjecting the layer and substrate to elevated temperature and pressure conditions at which the ultra-hard abrasive particles are crystallographically stable.

2. A method according to claim 1, wherein the bundle of fibres is extruded prior to being severed to produce the layer.

3. A method according to claim 1, wherein the core comprises a mixture of diamond or cubic boron nitride particles and an appropriatesolvent/catalyst, in particulate form, bonded into a coherent form by means of an organic binder.

4. A method according to claim 1, wherein the coating is bonded into a coherent form by means of an organic binder.

5. A method according to claim 1, wherein the carbide particles are tungsten carbide particles, tantalum carbide particles or molybdenum carbide particles.

6. A method according to claim 1, wherein the substrate is a cemented carbide substrate.

7. A method according to claim 1, wherein the coating comprises one or more layers.

8. A method according to claim 7, wherein the coating comprises more than one layer, each layer differing from an adjacent layer in physical and/or chemical properties.

9. A method according to claim 8, wherein one layer has coarser or finer carbide particles than the adjacent layer (s) or contains a different metal binder to that in the adjacent layer (s).

10. A method according to claim 1, wherein the tool component comprising the substrate has a working portion produced from the layer bonded to a surface thereof.

11. A method according to claim 10, wherein the working portion comprises a composite material comprising essentially a honeycomb structure of cemented carbide and abrasive compact material within the pores of the honeycomb structure and bonded to the honeycomb structure.

12. A method according to claim 11, wherein the pores of the honeycomb structure are ordered or random.

13. A method of producing a tool component including the steps of: (1) providing a plurality of fibres, each fibre having a core comprising a mixture of carbide particles and particulate binder metal, and a coating comprising a mass of ultra-hard abrasive
